(19) United States
(12) Patent Application Publication
(10) Pub. No.: US 2019/0022515 A1
(43) Pub. Date: Jan. 24, 2019

(54) CARD GAMING METHOD AND CARD GAMING SYSTEM

(71) Applicant: Kai-Ping Hung, Taichung City (TW)

(72) Inventor: Kai-Ping Hung, Taichung City (TW)

(21) Appl. No.: 15/658,354

(22) Filed: Jul. 24, 2017

(51) Int. Cl. A63F 1/00; A63F 1/06; A63F 1/14; G07F 17/32

(52) U.S. Cl. CPC A63F 1/00; A63F 1/067; A63F 2001/001; G07F 17/3293; A63F 1/14

(57) ABSTRACT

A card gaming method and a card gaming system are provided. The card gaming method is adapted for the card gaming system including at least one deck of playing cards and a dedicated gaming table. The dedicated gaming table is designed to include an ante area, a play area and a revenge area. The ante area accepts an ante wager being not less than a minimum ante. The card gaming method includes: dealing initial two cards to a player side in response to an ante wager being placed in the ante area by the player side; dealing a third card to the player side in response to a play wager being placed in the play area by the player side when a player score of the initial two cards on the player side is less than a play threshold; dealing a fourth card to the player side in response to a revenge wager being placed in the revenge area by the player side when a player score of the three cards on the player side is less than a revenge threshold.

### BACKGROUND OF THE INVENTION

### 1. Field of the Invention

The present invention generally relates to card games, in particular, to a card gaming method and a card gaming system with unconventional rules.

### 2. Description of Related Art

The Baccarat game is appealing to players because of its simple concepts and procedures that are readily understood. In traditional Baccarat or mini-baccarat, the rules of the timing when a player or a banker must take a hit are well defined. According to the rules of the game, the player or the banker eventually has either two or three cards in hand when resolving, dictated by the hitting rules of the game and the point count of the first two cards in each hand. The only decisions to be made by the player are whether to bet on the player hand, the banker hand or on a tie hand and the amount of the wager. There are a number of variations of the basic game of baccarat. The rules may vary slightly, and rules may vary from casino to casino, but the underlying game is the same. The underlying game is a competition between the hands of two players, usually referred as the banker hand and the player hand. All players at the table can place wagers, but only one player participates in the game by receiving a hand of cards. Both hands are dealt to designated “Banker” and “Player” positions on a central part of the layout. Initially, two cards are dealt to each of the participating player and the banker. Each initial or partial two-card hand is reviewed by the banker and the player. The results of the competition are determined by how close the point total to a value of nine is. Two card hands with a point total of 8 or 9 are naturals. Specifically, the rule for counting the point total is based on the added face value of the cards, with the values of the cards being Ace=1, 2=2, 3=3, 4=4, 5=5, 6=6, 7=7, 8=8, 9=9, 10=0, Jack=0, Queen=0, and King=0. Only the last digit of the sum of the point values of the cards is operative in the play of the game. For example, the added face value of 10, 11, 12, 13, 14, 15, 16, 17, 18, 19, and 20 would be read as 0, 1, 2, 3, 4, 5, 6, 7, 8, 9, and 0 in the game. A player places a wager on the player's hand winning, the banker's hand winning or a tie, by placing the wager in a designated space for a wager on the banker's hand, the player's hand or a tie hand. A commission is usually paid to the house from the winning bets on the banker's hand (e.g., 5% of the winning bet on the banker's hand), because the banker usually wins more often than the player. No commission is paid to the house when the player bets on the player hand. Depending on the odds provided by the house on a tie (usually from 8:1, 9:1 or 10:1), the house advantage is between 4.5% and 15%.

However, some players may not be interested in playing Baccarat because it appears to be such a simple game with little excitement and no chance for a significant payout on a hand without a large wager being placed. Accordingly, it would be desirable to design a new game, which can boost the player's interests in playing, and be easily learned from the knowledge of the traditional baccarat.

### SUMMARY OF THE INVENTION

Accordingly, the present invention is directed to a card gaming method and a card gaming system, which provide chances to take more hits and more betting opportunities for players, meanwhile provides good profits for the house.

An exemplary embodiment of the invention provides a card gaming method. The card gaming method is adapted for the card gaming system including at least one deck of playing cards and a dedicated gaming table. The dedicated gaming table is designed to include an ante area, a play area and a revenge area. The ante area accepts an ante wager being not less than a minimum ante. The card gaming method includes: dealing initial two cards to a player side in response to the ante wager being placed in the ante area by the player side; calculating a player score according to the initial two cards on the player side; dealing a third card to the player side in response to the play wager being placed in the play area by the player side when the player score of the initial two cards on the player side is less than a play threshold; calculating the player score according to the three cards on the player side; dealing a fourth card to the player side in response to the revenge wager being placed in the revenge area by the player side when the player score of the three cards on the player side is less than a revenge threshold; and calculating the player score according to the four cards on the player side.

Another exemplary embodiment of the invention provides a card gaming system. The gaming system includes a dealing unit and a dedicated gaming table. The dealing unit includes at least one deck of playing cards, and is configured to deal cards to a player side and a banker side. The dedicated gaming table is configured with the dealing unit, and includes an ante area, a play area, and a revenge area. The ante area accepts an ante wager being not less than a minimum ante. In response to the ante wager being placed in the ante area by the player side, the dealing unit deals initial two cards to the player side. In response to the play wager being placed in the play area by the player side when a player score of the initial two cards on the player side is less than a play threshold, the dealing unit deals a third card to the player side. In response to the revenge wager being placed in the revenge area by the player side when the player score of the three cards on the player side is less than a revenge threshold, the dealing unit deals a fourth card to the player side.

Based on the above, at least two additional areas are designed in the dedicated gaming table for buying more cards by players. As such, the card gaming method and the card gaming system of the invention can provide more betting opportunities, excitement, varieties of playing, and opportunities to obtain greater payout for players.

Meanwhile, good profits are also provided for the house that implements the card gaming method and the card gaming system of the invention.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of a card gaming system according to an embodiment of the invention.

FIG. 2 illustrates a schematic diagram of a dedicated gaming table according to an embodiment of the invention.

FIG. 3 illustrates a schematic diagram of a betting area on the dedicated gaming table on one player side according to an embodiment of the invention.

FIG. 4A illustrates a flowchart of a card gaming method regarding a player side according to an embodiment of the invention.

FIG. 4B illustrates a flowchart of a card gaming method regarding a player side according to another embodiment of the invention.

FIG. 5 illustrates a flowchart of a card gaming method regarding a banker side according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

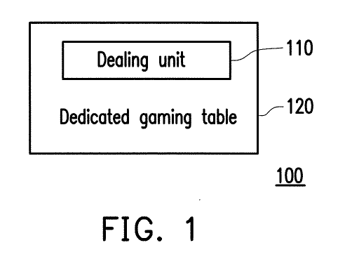

FIG. 1 illustrates a block diagram of a card gaming system according to an embodiment of the invention. Referring to FIG. 1, the card gaming system 100 includes at least a dealing unit 110 and a dedicated gaming table 120. The dealing unit 110 is filled with at least one deck of playing cards (e.g., 6-8 decks), for dealing cards to a banker side and at least one player side. For example, the dealing unit 110 may be a dealing shoe or an auto shuffler, which is not limited herein. The dedicated gaming table 120 is configured with the dealing unit 110, and designed for the card gaming method provided in the embodiment of the invention. Details of said card gaming method will be described in the descriptions set forth below.

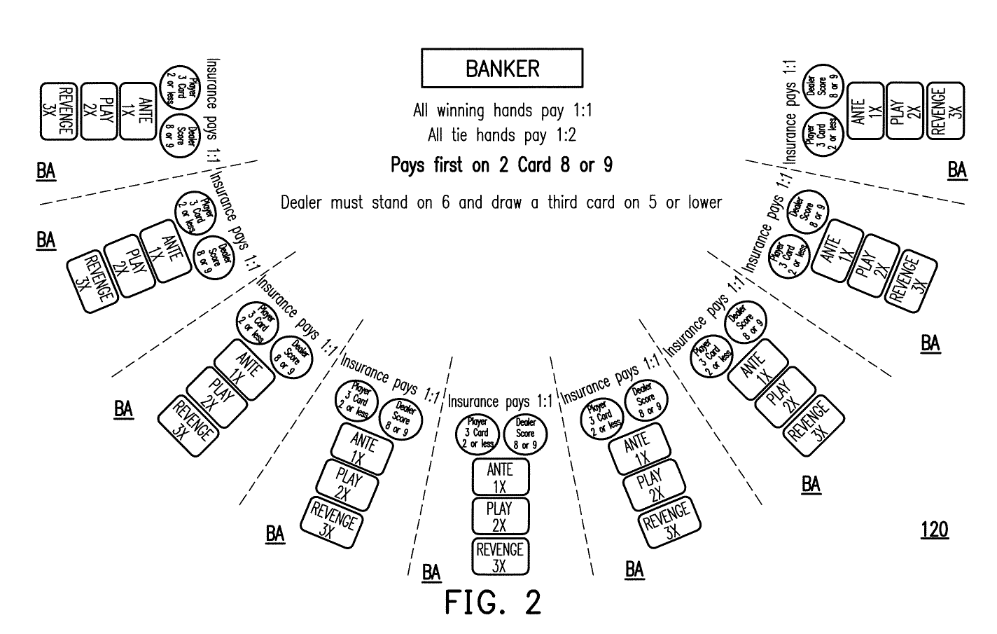

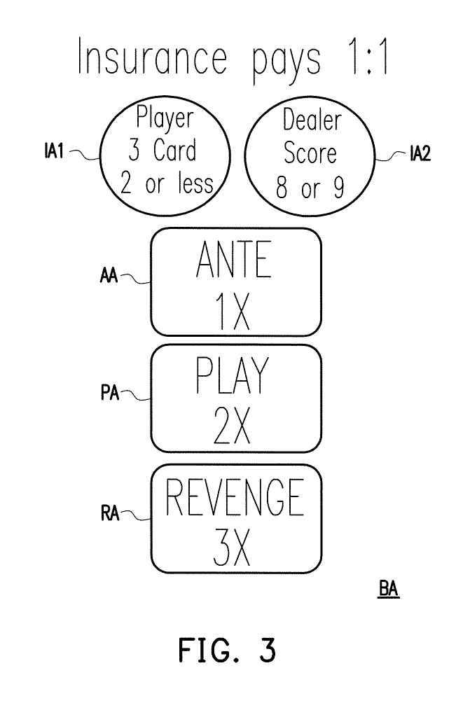

FIG. 2 illustrates a schematic diagram of a dedicated gaming table according to an embodiment of the invention. FIG. 3 illustrates a schematic diagram of a betting area on the dedicated gaming table on one player side according to an embodiment of the invention.

In one embodiment, the dedicated gaming table 120 is designed in a layout as shown in FIG. 2. Advantageously, the card gaming system 100 allows a banker side and more than one player side to play on the dedicated gaming table, and a bet area BA is set on the dedicated gaming table 120 on each player side. Referring to FIG. 3, the bet area BA includes at least an ante area AA, a play area PA, and a revenge area RA. In this embodiment, the bet area BA further includes two insurance areas IA1 and IA2. In some embodiments, the bet area may include more or less than two insurance areas, the number of the insurance area is not limited in the present invention.

Each ante area AA only accepts wager of which the amount is not less than a minimum ante (e.g., $5, $10, or $20, etc.). Value of the minimum ante is not limited herein, one of ordinary skills in the art may adjust the minimum ante according to their own requirements. Specifically, players can only place the wager (i.e., ante wager) which is not less than the minimum ante in the ante area.

In one embodiment, each play area PA only accepts wager of which the amount is not less than the ante wager placed in the ante area. Specifically, players can only place the wager (i.e., play wager) which is not less than the ante wager in the ante area. That is, when wagers are placed in the play area PA, there must be some wager in the ante area AA already. However, the amount of the play wager is not limited in herein, which can be ruled by the house. In this embodiment, a casino sets a rule that the play wager must be double to the ante wager. In another embodiment, a casino may set a rule that the play wager must be equal to the ante wager.

In one embodiment, each revenge area RA only accepts wager of which the amount is not less than the ante wager placed in the ante area. Specifically, players can only place the wager (i.e., revenge wager) which is not less than the ante wager in the ante area, when wagers are placed in the play area PA already. That is, when wagers are placed in the revenge area RA, there are wagers in both the ante area AA and the play area PA already. However, the amount of the revenge wager is not limited in herein, which can be ruled by the house. In this embodiment, a casino sets a rule that the revenge wager must be triple to the ante wager. In another embodiment, a casino may set a rule that the revenge wager must be equal to the ante wager.

Each insurance area corresponds to a score condition. In one embodiment, the insurance area only accepts wager of which the amount is within a preset range (for example, half to triple of the minimum ante), but which is not limited herein. In this embodiment, the bet area BA includes two insurance areas IA1 and IA2. The insurance IA1 corresponds to a score condition that the player gets a score not greater than 2 when three cards in hand, and the insurance IA2 corresponds to another score condition that the dealer gets a final banker score of 8 or 9. Player has an option to not place any wager in the insurance area IA, or to place wager in at least one of the insurance area IA for insurance in this embodiment.

After descriptions of the card gaming system 100 and the dedicated gaming table 120 provided in the present invention, the card gaming method provided will be illustrated by referring to the described card gaming system 100 in the embodiments.

It should be noted that the card gaming system 100 may include a physical dealing unit 110 and a physical dedicated gaming table 120 set inside a casino, and the cards are dealt by a dealer or automatically dealt by the dealing unit 110, but which is not limited in the invention. In some embodiments, the card gaming system 100 may also be implemented by a processor of an electronic device, which creates an environment including a virtual dealing unit 110 and a virtual dedicated gaming table 120 as introduced before, and allows for a plurality of players to participate in the game online or offline.

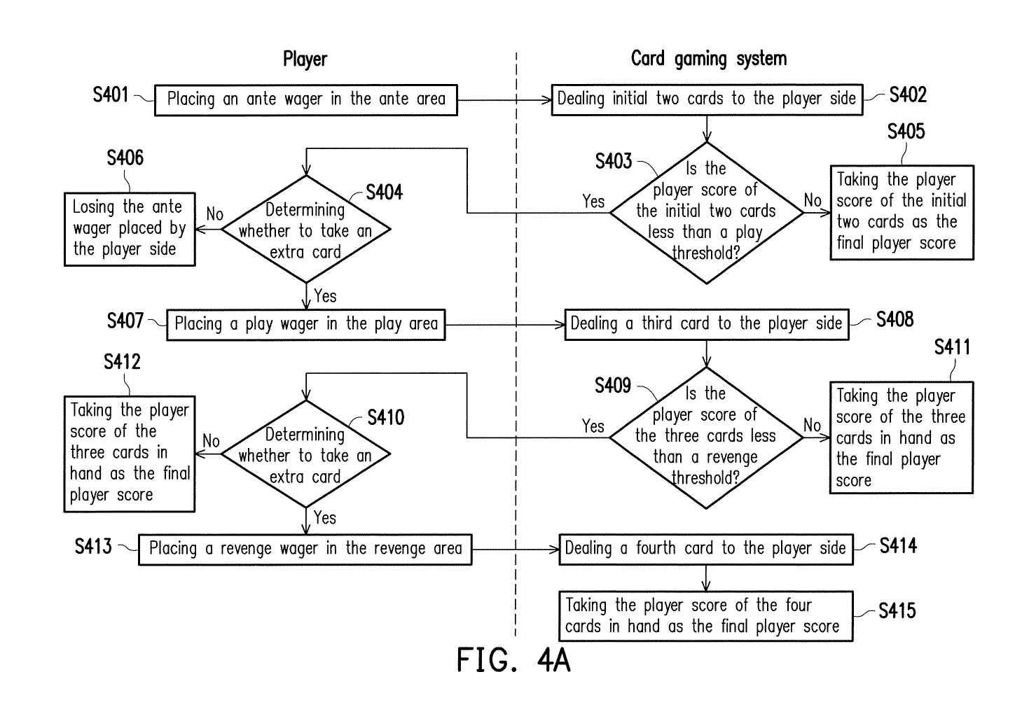

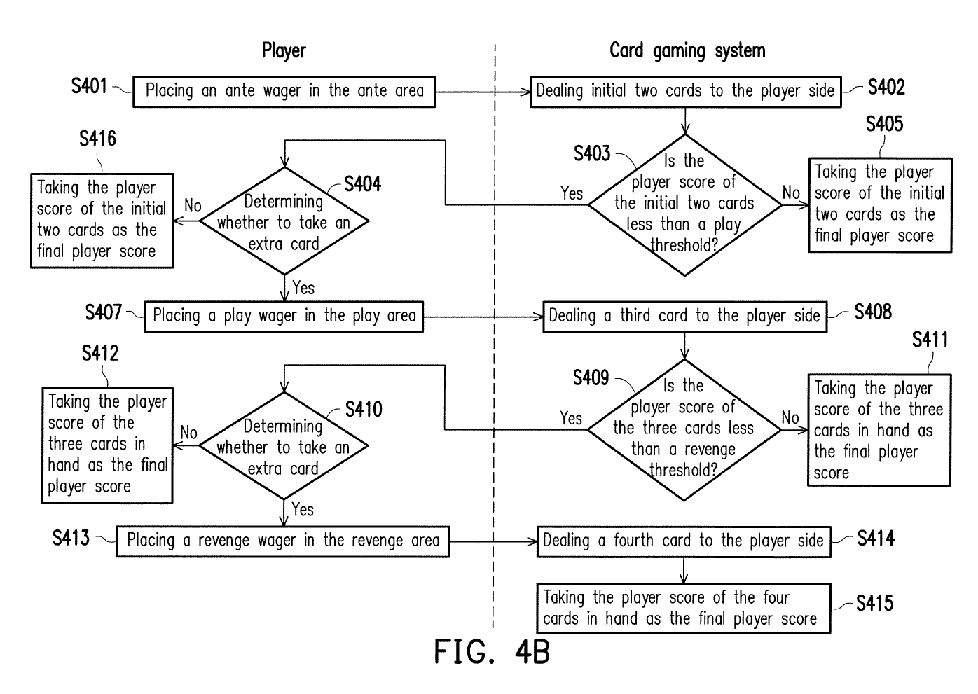

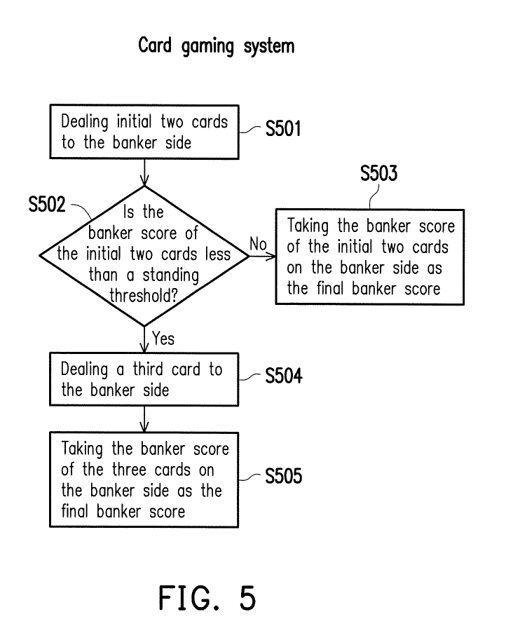

FIG. 4A illustrates a flowchart of a card gaming method regarding a player side according to an embodiment of the invention. FIG. 4B illustrates a flowchart of a card gaming method regarding a player side according to another embodiment of the invention. FIG. 5 illustrates a flowchart of a card gaming method regarding a banker side according to an embodiment of the invention.

It is noted that the card gaming method adopts the same rule for calculating scores as a conventional Baccarat for description convenience in this embodiment. For example, when a player has two cards in hand with face values of 6 and 8, the player gets a player score of 4. For another example, when a player has three cards in hand with face values of 3, 5 and Jack, the player gets a player score of 8. The rule for calculating scores can be learned from the well-defined rules of Baccarat games, which are not repeatedly herein.

However, the cards used and the rule for calculating scores is not limited in the present invention. In some embodiments, a casino may abandon all the Jacks, the Queens, and the Kings from the playing cards used by the casino, and adopt its own rule for calculating the scores of the cards in the player hand.

Referring to FIG. 4A and FIG. 5, a player joins the game on a player side by placing an ante wager in the ante area AA (S401). In response to the ante wager being placed in the ante area AA, the dealer deals initial two cards to the player side (S402). On the other hand, the dealer also deals initial two cards to a banker side (S501). The dealer may be referred to a person who works for a casino operating the dealing unit 110, or the automatic dealing unit 110 itself, which is not limited herein.

The sequence of dealing is depending on the house, which is not limited in the embodiment. In one embodiment, it's the first card and the third card being dealt to the player side, and the second card and the fourth card being dealt to the banker side when there are only one player side and one banker side participating in the game. In another embodiment, the first two cards are dealt to the banker side and the next two cards are dealt to the player side when there are only one player side and one banker side participating in the game.

Regarding the initial two cards on the banker side, in one embodiment, one of the initial two cards is revealed; in another embodiment, no card is revealed. In other words, how many card of the initial two cards on the banker side is revealed is depending on the house and not limited by the invention.

A player score of the initial two cards on the player side is calculated and the player score is compared with a play threshold (S403). The play threshold is used for determining whether the player is eligible to take an extra card when the winning rate of the player is relatively low, and the value may be set by the house according to the requirements thereof. In one embodiment, the player reveals the initial two cards in the step S403 and is eligible to take an extra card only when the player score is less than the play threshold (e.g., 6). It is noted that the limitation for taking the third card can be eliminated by setting the play threshold as a high score that can never be reached (e.g., 10). As a result, the player is always eligible to take the third card.

If the player score is not less than the play threshold, the player score of the initial two cards is taken as the final player score (S405), and the step S501 proceeds to the step S502 in FIG. 5 (described later). Advantageously, the player is eligible to take an extra card if the player score is less than the play threshold, as long as the player bets more. The player may determine whether to place a play wager in the play area PA for taking an extra card (S404). If the player determines not to take the third card, the player side loses the ante wager placed by the player in this embodiment (S406). If the player determines to take the third card, the player may place the play wager in the play area PA (S407).

In another embodiment, when the player is eligible to take an extra card, the casino may also provide the option for the player to continue the game with the initial two cards in hand. Referring to FIG. 4B, the step S406 in FIG. 4A is replaced by the step S416 in FIG. 4B. To be specific, if the player determines not to take the third card in the step S404, the player may continue the game with the initial two cards in hand, and the player score of the initial two cards will be calculated as the final player score (S416). In this case, the player still has a chance to win even if the player score of the initial two cards is less than the play threshold.

As mentioned before, in the embodiment, the play wager is limited to be double of the ante wager that has been already placed in the ante area. For example, if the player placed double the minimum ante in the ante area AA (e.g., $40), the player has to place quadruple the minimum ante in the play area PA (e.g., $80) for taking an extra card.

In response to the play wager being placed in the play area PA, the dealer deals a third card to the player side (S408). A player score of the three cards on the player side is calculated and the player score is compared with a revenge threshold (S409). The revenge threshold is used for determining whether the player is eligible to take an extra card when the winning rate of the player is relatively low, and the value may be set by the house according to the requirements thereof. In one embodiment, the player reveals the third card in the step S409 and is eligible to take an extra card only when the player score of the three cards in hand is less than the revenge threshold (e.g., 1). It is noted that the limitation for taking the fourth card can be eliminated by setting the play threshold as a high score that can never be reached (e.g., 10). As a result, the player is always eligible to take the fourth card.

If the player score is not less than the revenge threshold, the player score of the three cards is taken as the final player score (S411), and the step S501 proceeds to the step S502 in FIG. 5 (described later). Advantageously, the player is eligible to take an extra card if the player score of the three cards in hand is less than the revenge threshold, as long as the player bets more. The player may determine whether to place a revenge wager in the revenge area RA for taking another card (S410). If the player determines not to take another card, the player score of the three cards in hand is taken as the final player score (S412). If the player determines to take the fourth card, the player may place the revenge wager in the revenge area RA (S413).

As mentioned before, in the embodiment, the revenge wager is limited to be triple of the ante wager that has been already placed in the ante area. For example, if the player placed double the minimum ante in the ante area AA (e.g., $40), the player has to place sextuple the minimum ante in the revenge area RA (e.g., $120) for taking a fourth card.

In response to the revenge wager being placed in the revenge area RA, the dealer deals a fourth card to the player side (S414). A player score of the four cards on the player side is calculated as the final player score (S415). In the embodiment, the player can receive up to four cards, but which is not limited herein. In other embodiments, the dedicated gaming table 120 may have more areas, and the player may have more chances to place more wagers on the areas for taking more cards.

It is note that the steps S401, S404, S407, S410 and S413 of FIG. 4A and FIG. 4B are performed by the player side, and the steps S402, S403, S408, S409 and S414 of FIG. 4A and FIG. 4B are performed by the provided card gaming system 100 in the embodiment.

After the final player score is obtained, the step S501 proceeds to S502. A banker score is calculated according to the initial two cards on the banker side, and the banker score is compared with a standing threshold (S502). The standing threshold is used for determining whether a third card has to be dealt to the banker side, and the value may be set by the house according to the requirements thereof. In one embodiment, the two initial cards on the banker side are revealed in the step S502, and the third card has to be dealt to the banker side when the banker score of the initial two cards in hand is less than the standing threshold (e.g., 6). Otherwise, the banker side stands.

Specifically, if the banker score of the initial two cards on the banker side is less than the standing threshold, the dealer deals a third card to the banker side (S504) and the final banker score is calculated according to the banker score of the three cards on the banker side (S505). On the other hand, if the banker score of the initial two cards on the banker side is not less than the standing threshold, the banker side stands and the final banker score is calculated according to the banker score of the initial two cards on the banker side (S503).

Accordingly, the player side can buy up to four cards by placing wager in each areas on the dedicated gaming table 120 in the embodiment of the invention, according to the decision made by the player, while the banker side receives up to three cards dictated by the rules of the game without personal decisions.

In the embodiment, the final player score is compared with the final banker score, and game is resolved according to the comparison result. The player side wins when the final player score is higher than the final banker score. Once the player side wins, the player side is paid according to a gaming odds predetermined by the house. In the embodiment, if the player side wins, the player side is paid at odds of 1:1. For example, if the player side wins with a two cards hand, the ante wager in the ante area

AA (e.g., $40) can be taken back to the player side and another ante wager (e.g., $40) is further paid to the player side by the house. If the player side wins with a three cards hand, the ante wager in the ante area AA (e.g., $40) and the play wager in the play area PA (e.g., $80) can be taken back to the player side, and another ante wager (e.g., $40) and another play wager (e.g., $80) are further paid to the player side by the house. If the player side wins with four cards in hand, the ante wager in the ante area AA (e.g., $40), the play wager in the play area PA (e.g., $80) and the revenge wager in the revenge area RA (e.g., $120) can be taken back to the player side, and another ante wager (e.g., $40), another play wager (e.g., $80), and another revenge wager (e.g., $120) are further paid to the player side by the house.

For more betting opportunities and greater payout, various features may be selectively added into the card gaming method of the invention. Several embodiments of the features are illustrated in the following.

Insurance Side-Wager

Referring back to FIGS. 3 to 5, in one embodiment, the betting area BA of the dedicated gaming table 120 includes the insurance area IA1 and IA2. The insurance IA1 corresponds to a score condition that the player gets a score not greater than 2 when three cards in hand, and the insurance IA2 corresponds to another score condition that the dealer gets a final score of 8 or 9.

The player side can place an insurance wager in the insurance area IA1 between the steps S407 and S408, for betting on the player score of the three cards on the player side is less than a preset number (e.g., 3). Once the player score of the three cards on the player side is less than the preset number (e.g., 3), the player side is paid according to a gaming odds (e.g., 1:1) of the insurance area IA1 and the insurance wager placed in the insurance area IA1.

The player side can place an insurance wager in the insurance area IA2 right after the steps 402 and 501 when the banker side has not reveal both the initial two cards, for betting on the final banker score is 8 or 9. Once the final banker score on the banker side is 8 or 9, the player side is paid according to the gaming odds (e.g., 1:1) of the insurance area IA2 and the insurance wager placed in the insurance area IA2. It is noted that one of ordinary skills in the art may design their own score conditions corresponding to the insurance areas, which is not limited herein. In other embodiments, an insurance area may correspond to the score condition that a specific score in a specific number of cards equals to a specific value. For example, the player score of the three cards on the player side is 5, or the banker score of the initial two cards on the banker side is 8 or 9. Different score conditions may correspond to different odds, which is predetermined by the house and not limited in the present invention.

It is noted that the range of the insurance wager may be predetermined by the house. In one embodiment, the insurance wager may be limited from half to triple of the minimum ante. In another embodiment, the insurance wager may be placed in the insurance area without limitations.

It is noted that the feature of the insurance side-wager can be selectively activated. In one embodiment, only one of the insurance areas IA1 and IA2 is activated. In another embodiment, both the insurance areas IA1 and IA2 are activated. In other embodiments, the dedicated gaming table 120 may include more insurance areas corresponding to more score conditions, which is not limited in the invention.

Bonus Payouts

In one embodiment, bonus may be paid to the player side when the player side wins and certain score conditions are met. For example, when a final player score of the initial two cards on the player side is 9, then the player side is paid at odds of 1:1; when a final player score of the three cards on the player side is 9, then the player side is paid at odds of 2:1; and when a final player score of the four cards on the player side is 9, then the player side is paid at odds of 3:1. For another example, when a final player score of the initial two cards on the player side is 8 or 9, then the player side is paid at odds of 1:1; when a final player score of the three cards on the player side is 8 or 9, then the player side is paid at odds of 3:2; and when a final player score of the four cards on the player side is 8 or 9, then the player side is paid at odds of 2:1.

The certain score conditions and the corresponding odds may be predetermined by the house, which is not limited in the present invention.

Pay First

The pay first feature indicates that the player side may be paid earlier if some specific conditions are met, where said specific conditions are predetermined by the house and not limited in the present invention.

In one embodiment, the player side wins and be paid whenever the player score meets a specific score. For example, the specific score is set as 9, then the player side gets paid whenever the player score is 9. In one embodiment, when a player score of the initial two cards is 9, the ante wager in the ante area AA is paid straight away at odds of 1:1; when a player score of the three cards on the player side is 9, the ante wager in the ante area AA and the play wager in the play area PA are paid straight away at odds of 1:1; and when a player score of the four cards on the player side is 9, the ante wager in the ante area AA, the play wager in the play area PA and the revenge wager in the revenge area RA are paid straight away at odds of 1:1

In another embodiment, the player side can only be paid first when the player score of the initial two cards or all four cards meets the specific score. For example, when a player score of the initial two cards is 9, the ante wager in the ante area AA is paid straight away at odds of 1:1; and when a player score of the four cards on the player side is 9, the ante wager in the ante area AA, the play wager in the play area PA and the revenge wager in the revenge area RA are paid straight away at odds of 1:1. When a player score of the three cards on the player side is 9, the player side is not paid until the final scores are resolved.

Tie Advantage

In one embodiment, the final player score may equal to the final banker score. Therefore, a special tie rule may be designed for resolving when the final player score equals to the final banker score (i.e., two sides tie).

The special tie rule may be set to favour the player side or the banker side. When the special tie rule is set to favour the player side, the player side may be paid when two sides tie. In one embodiment, when the two sides tie, the player side may be paid at odds of 1:2. For example, if the ante wager and the play wager are placed, the player side can take the ante wager and the play wager back and further get paid half the ante wager and the play wager when the two sides tie. In another embodiment, when the two sides tie, the player side may be paid the ante wager. When the special tie rule is set to favour the banker side, the player side may lose when two sides tie. In one embodiment, when the two sides tie, the player side may lose a percentage (e.g., 50%) of all wagers placed. For example, if the ante wager and the play wager are placed, the player side can only take half the ante wager and the play wager back when the two sides tie. In another embodiment, when the two sides tie, the player side may lose the ante wager.

Point Difference Advantage

In one embodiment, the game may be resolved further according to a difference between the final player score and the final banker score.

In one embodiment, the player side loses if the final player score is less than the final banker score, but does not lose that much when the final player score is only 1 less than the final banker score. For example, the player side loses all the wagers placed on the table when the final player score is 4 and the final banker score is more than 5. And, the player side loses half the wagers placed on the table when the final player score is 4 and the final banker score is 5. In another embodiment, the player side does not lose when the final player score is only 1 less than the final banker score, and the player side can take all the wager back.

In one embodiment, the player side wins if the final player score is more than the final banker score, but does not win that much when the final player score is only 1 more than the final banker score. For example, the player side wins at odds of 1:1 when the final player score is 6 and the final banker score is less than 5. And, the player side wins at odds of 1:2 when the final player score is 6 and the final banker score is 5. In another embodiment, the player side does not win when the final player score is only 1 more than the final banker score, and the player side can take all the wager back.

The rules for resolving according to the score difference between the final player score and the final banker score and the associate payouts can be predetermined by the house, which is not limited herein.

Preset Score Advantage

In one embodiment, the game may be resolved according to a score condition. For example, once the player side wins by the final player score being a preset score, the player side does not win that much, or the player side does not win at all. For another example, once the player side loses to the final banker score being a preset score, the player side does not lose that much, or the player side does not lose at all.

In one embodiment, the preset score is set as 6, and the player side wins at odds of 1:1 when the final player score is higher than the final banker score, but the final player score is not being 6. However, the player side only wins at odds of 1:2 when the final player score is 6 and the final banker score is less than 6. In another embodiment, the preset score is set as 6 as well, and the player side forfeits all the wagers placed when the final player score is less than the final banker score, but the final banker score is not being 6. However, the player side takes half of the wagers placed when the final banker score is 6 and the final player score is less than 6.

Special Banker Natural Rule

A special banker natural rule may be set to favour the player side. For example, once the special banker natural rule is turned on, the player side may only lose a percentage (e.g. 50%) of all wagers placed or lose the ante wager when the banker side receives a score of 8 or 9 on the initial two cards (e.g. natural). In one embodiment, if the ante wager (e.g., $40), the play wager (e.g., $80) and the revenge wager (e.g., $120) are placed, and the player loses to the banker's hand with a score of 8 or 9 on the initial two cards, the player side will only lose half of the ante wager, the play wager and the revenge wager (e.g., $120). In another embodiment, if the ante wager (e.g., $40), the play wager (e.g., $80) and the revenge wager (e.g., $120) are placed, and the player loses to the banker's hand with a score of 8 or 9 on the initial two cards, the player side will only lose the ante wager (e.g., $40) and be able to take the play wager (e.g., $80) and revenge wager (e.g., $120) back.

It should be noted that the aforementioned embodiments are mere exemplary examples for illustrating several features that can be added into the card gaming method provided in the invention. One or more features can be selectively activated in each game. However, one of skills in the art may add other features or advantages to the provided card gaming method, and design the odds according to their requirements, which are not limited in the invention.

In summary, the card gaming method and the card gaming system of the embodiments of the invention provide more betting opportunities, excitement, varieties of playing, and opportunities to obtain greater payout for players. Meanwhile, good profits are also provided for the house that implements the card gaming method and the card gaming system of the embodiments of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A card gaming method adapted for a card gaming system comprising at least one deck of playing cards and a dedicated gaming table, wherein the dedicated gaming table comprises an ante area, a play area and a revenge area, wherein the card gaming method comprising:
dealing initial two cards to a player side in response to an ante wager being placed in the ante area by the player side;
calculating a player score according to the initial two cards on the player side;
dealing a third card to the player side in response to a play wager being placed in the play area by the player side when the player score of the initial two cards on the player side is less than a play threshold;
calculating the player score according to the three cards on the player side;
dealing a fourth card to the player side in response to a revenge wager being placed in the revenge area by the player side when the player score of the three cards on the player side is less than a revenge threshold; and
calculating the player score according to the four cards on the player side, wherein the ante area of the dedicated gaming table accepts the ante wager being not less than a minimum ante.

2. The card gaming method as claimed in claim 1, further comprising:
dealing initial two cards to a banker side, and calculating a banker score according to the initial two cards on the banker side;
if the banker score of the initial two cards on the banker side is less than a standing threshold, dealing a third card to the banker side and calculating a final banker score according to the three cards on the banker side; and
if the banker score of the initial two cards on the banker side is not less than the standing threshold, taking the banker score as the final banker score.

3. The card gaming method as claimed in claim 2, wherein before dealing the third card to the player side, the card gaming method further comprises:
determining whether the player score of the initial two cards on the player side is less than the play threshold;
if the player score of the initial two cards on the player side is less than the play threshold, dealing the third card to the player side in response to the play wager being placed in the play area by the player side; and
if the player score of the initial two cards on the player side is not less than the play threshold, taking the player score of the initial two cards on the player side as the final player score.

4. The card gaming method as claimed in claim 3, wherein before dealing the fourth card to the player side, the card gaming method further comprises:
determining whether the player score of the three cards on the player side is less than the revenge threshold;
if the player score of the three cards on the player side is less than the revenge threshold, dealing the fourth card to the player side in response to a revenge wager being placed in the revenge area by the player side; and
if the player score of the three cards on the player side is not less than the revenge threshold, taking the player score of the three cards on the player side as the final player score.

5. The card gaming method as claimed in claim 4, further comprising:
comparing the final banker score and the final player score; and
resolving according to a gaming odds and a comparison result.

6. The card gaming method as claimed in claim 5, further comprising:
paying the player side according to the gaming odds and a score condition.

7. The card gaming method as claimed in claim 5, wherein resolving according to the gaming odds and the comparison result comprises:
resolving according to the gaming odds, and a difference between the final banker score and the final player score.

8. The card gaming method as claimed in claim 5, further comprising:
resolving according to a tie rule when the final banker score equals to the final player score.

9. The card gaming method as claimed in claim 2, wherein the dedicated gaming table further comprises an insurance area, wherein each insurance area corresponds to a score condition, wherein the card gaming method further comprises:
determining whether the banker score or the player score meets the score condition; and
paying the player side when the banker score or the player score meets the score condition, according to a gaming odds and an insurance wager placed in the insurance area by the player side.

10. The card gaming method as claimed in claim 1, wherein the play area of the dedicated table accepts the play wager being not less than the ante wager, and the revenge area of the dedicated table accepts the revenge wager being not less than the ante wager.

11. The card gaming method as claimed in claim 2, wherein the player score and the banker score are calculated based on a baccarat game.

12. A card gaming system, comprising:
a dealing unit comprising at least one deck of playing cards, and configured to deal cards to a player side and a banker side; and
a dedicated gaming table configured with the dealing unit, comprising an ante area, a play area, and a revenge area, wherein the ante area accepts an ante wager being not less than a minimum ante,
wherein in response to the ante wager being placed in the ante area by the player side, the dealing unit deals initial two cards to the player side,
wherein in response to the play wager being placed in the play area by the player side when a player score of the initial two cards on the player side is less than a play threshold, the dealing unit deals a third card to the player side, and
wherein in response to the revenge wager being placed in the revenge area by the player side when the player score of the three cards on the player side is less than a revenge threshold, the dealing unit deals a fourth card to the player side.

13. The card gaming system as claimed in claim 12, wherein the dealing unit deals initial two cards to the banker side, and the dealing unit further deals a third card to the banker side when a banker score of the initial two cards on the banker side is less than a standing threshold.

14. The card gaming system as claimed in claim 12, wherein the dedicated gaming table further comprises an insurance area, wherein each insurance area corresponds to a score condition.

15. The card gaming system as claimed in claim 12, wherein the play area of the dedicated table accepts the play wager being not less than the ante wager, and the revenge area of the dedicated table accepts the revenge wager being not less than the ante wager.
